(19) United States
(12) Patent Application Publication
(10) Pub. No.: US 2025/0204326 A1
(43) Pub. Date: Jun. 26, 2025

(54) CROP PICK-UP MEANS AND WORKING IMPLEMENT

(71) Applicant: DEERE & COMPANY, Moline, IL (US)

(72) Inventors: Florian Benoit-Guerindon, Talmay (FR); Emmanuel CHAPON, Velet (FR); Matthieu DUTERTRE, Chemaudin Et Vaux (FR)

(21) Appl. No.: 18/940,359

(22) Filed: Nov. 7, 2024

(30) Foreign Application Priority Data
Dec. 20, 2023 (DE) 102023135966.5

(51) Int. Cl. A01D 89/00

(52) U.S. Cl. CPC A01D 89/002; A01D 89/005

(57) ABSTRACT

A crop pick-up for an agricultural working implement includes a housing, having a pick-up device which is supported on the ground via at least one support wheel, and at least two horizontally spaced articulation levers which receive and support the pick-up device therebetween. The pick-up device is coupled to the articulation levers so as to be at least substantially vertically movable relative to the articulation levers.

### CROSS-REFERENCE TO RELATED APPLICATIONS

This application claims priority to and the benefit of German Patent Application No. 102023135966.5, filed on Dec. 20, 2023, the disclosure of which is hereby incorporated by reference.

### TECHNICAL FIELD

The disclosure generally relates to a crop pick-up for an agricultural working implement.

### BACKGROUND

Crop pick-up means are used on agricultural working implements, for example on presses, balers, forage harvesters or loader wagons, in order to pick up material, in particular loose crops, from the ground. The loose crops are normally previously cut harvested crops, for example in the form of hay, straw or silage. Such crop pick-up means are commonly also referred to as pick-ups or a pick-up mechanism.

Known crop pick-up means are commonly supported on the ground by means of support wheels so as to be able to follow the contour of the ground during use. For example, DE202020103608U1 presents a crop pick-up means which is suspended at opposite end portions by in each case two control arms, each of which is articulatedly supported at one side on a pick-up drum and is articulatedly supported at the other side on a machine frame part.

Such a crop pick-up means, and a working implement having a crop pick-up means, consists of numerous individual parts, are complex and thus expensive.

### SUMMARY

A crop pick-up for an agricultural working implement is provided. The crop pick-up includes a housing, a pick-up device and at least two horizontally spaced articulation levers. The articulation levers between them support the pick-up device, which is supported on the ground via at least one support wheel. The pick-up device is received by the articulation levers so as to be at least substantially vertically movable, such that it can follow the contour of the ground, or changes in the contour, in particular transversely with respect to the direction of travel. Since the pick-up device is supported by the articulation levers, which are preferably arranged to the right and to the left of the pick-up device, the pick-up device can move at least substantially vertically in relation to the two articulation levers. A vertical and a swinging movement, and thus an additional degree of freedom of sorts, can thus be implemented. It is not necessary for a fixed swing axis to be determined for this purpose. Rather, the pick-up device can swing about a virtual, vertically movable swing axis. The working implement may include a press, in particular an agricultural baler, for example a baler for forming round cylindrical bales, that is to say a roundbaler. Use on a press for forming square bales, on a loader wagon, on a forage harvester or on any other suitable working implement is however also conceivable. The crop for pressing is in particular hay, straw or silage. It may however also be any other, in particular agricultural, harvested crop, or any other material.

If the articulation levers are supported on the housing so as to swing about a substantially horizontal axis that extends transversely with respect to the direction of travel, they can easily follow a contour of the ground which changes in the direction of travel. This swinging movement about the axis may be superposed on the vertically movable swinging movement of the pick-up device, such that the crop pick-up means can easily compensate for changes in the ground both in the direction of travel and transversely with respect to the direction of travel.

It is particularly advantageous if each articulation lever has at least one guide element for in particular movably supporting the pick-up device.

It is conceivable that each of the articulation levers has only one guide element. It is however particularly advantageous if at least one of the articulation levers has multiple, preferably two, guide elements. These guide elements extend in particular substantially in parallel.

The guide element or the guide elements may for example be designed as rails, or may be of any other suitable design. It is however particularly favorable and/or simple in terms of production if a guide element/the guide elements is/are in the form of a slot or in the form of slots.

If a conveying rotor is provided on the crop pick-up means, then a particularly simple geometry is obtained if said conveying rotor can rotate about the axis, or an axis of rotation of the conveying rotor and the axis coincide or are congruent.

It is particularly favorable if the pick-up device has a rotatable conveying device. Such a conveying device may for example be in the form of a spike carrier.

If the conveying rotor and/or the conveying device can be driven by a traction mechanism drive, this is particularly simple in terms of production and requires little maintenance. A traction mechanism drive commonly has two or more drive pulleys or toothed wheels around which a traction mechanism is looped. Since the pick-up device is supported movably in the articulation levers, twisting of the traction mechanism can be prevented. For this purpose, the pick-up device may be arranged between the articulation levers and at least one drive pulley or one drive toothed wheel outside the articulation levers.

If the traction mechanism drive is in the form of a chain drive, this can counteract slipping of the traction mechanism and is conducive to establishing a synchronized transmission of drive.

It is particularly advantageous if a working implement, in particular an agricultural working implement, is equipped with a crop pick-up means as described above. Such a working implement may for example be a baler, and in this case a baler for producing either round cylindrical bales or square bales. The working implement may also be a forage harvester, a combine harvester, a loader wagon or any other suitable, in particular agricultural, working implement.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a side view of a working implement having a crop pick-up including a pick-up device, which is supported on the ground via support wheels.

FIG. 2 is an enlarged illustration of the pick-up device.

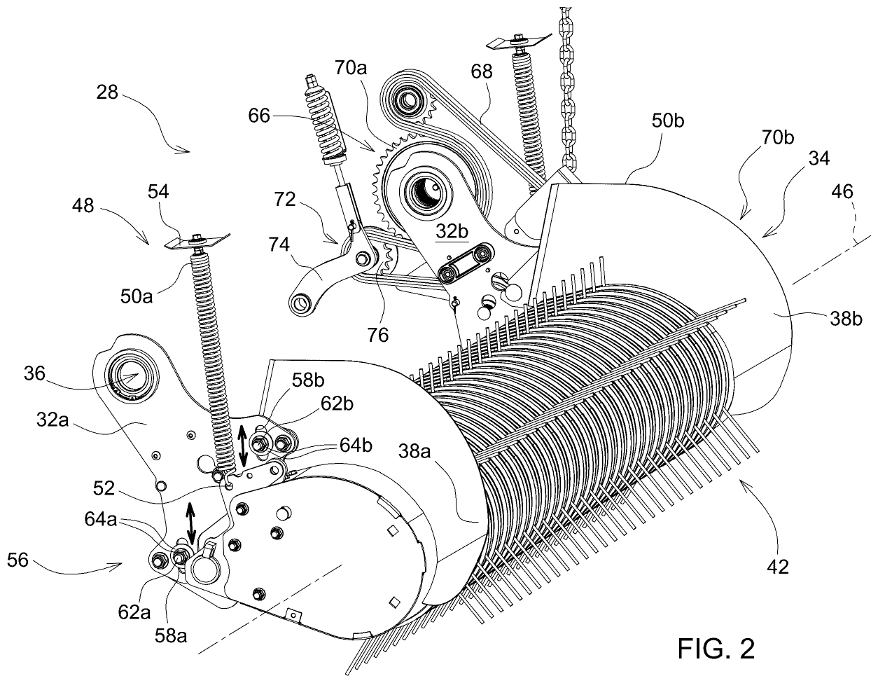

FIG. 3 is a right-hand side region of the pick-up device in a partially exploded illustration.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

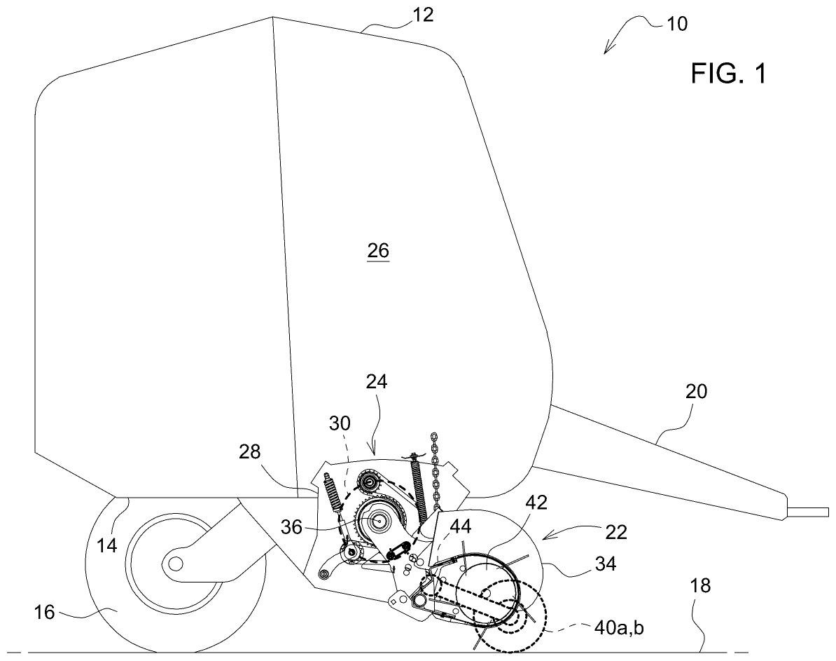

Referring to the Figures, wherein like numerals indicate like parts throughout the several views, a working implement is generally shown at 10 in FIG. 1. FIG. 1 illustrates an embodiment of the working implement 10 in the form of an agricultural press for producing round cylindrical bales from harvested crops. The working implement 10 has a frame 14 which bears a housing 12 and which is supported on the ground 18 via a running gear 16.

A drawbar 20 is arranged on the front side of the frame 14 in order to enable the working implement 10 to be hitched to a towing vehicle (not shown), for example an agricultural tractor, and towed over a field. A crop pick-up means 22 in the form of a pick-up is used to pick up harvested crops lying on the ground 18, for example hay or straw that has been deposited in a swath. The harvested crop picked up by the crop pick-up 22 is fed via an inlet 24 to a press chamber 26 and is rolled up spirally therein to form a round cylindrical bale, is tied, and is subsequently deposited on the ground 18.

In the present exemplary embodiment, the crop pick-up 22 has a housing 28, a conveying rotor 30, two articulation levers 32a, 32b, and a pick-up device 34. The conveying rotor 30 is supported so as to be rotatable about an axis 36 which extends substantially horizontally and transversely with respect to the direction of travel. The articulation levers 32a, 32b in turn are supported so as to be pivotable about the axis 36 and extend at least partially forward from said axis in relation to the direction of travel of the working implement 10. The pick-up device 34 is received movably between the articulation levers 32a, 32b.

The pick-up device 34 has a housing 38, two support wheels 40a, 40b, and a conveying device 42 in the form of a spike rotor. The support wheels 40a, 40b are pivotable on the side walls 38a, 38b about a wheel axle 44 which supports the conveying device 42 rotatably about a rotor axis 46. Also provided is a spring device 48 having a first spring 50a and a second spring 50b. The springs 50a, 50b engage at one end on one of the side walls 38a, 38b at a first fastening point 52 and at the other end on the housing 28 at a second fastening point 54.

A detailed description will now be given below of the manner in which the pick-up device 34 is received on the articulation levers 32a, 32b. For this purpose, the articulation levers 32a, 32b each have two spaced guide elements 58a, 58b in a region 56 situated opposite the axis 36. In the exemplary embodiment, said guide elements 58a, 58b are in the form of slots and are arranged in parallel, wherein they are formed into the articulation levers 32a, 32b so as to be spaced both in a horizontal direction and in a vertical direction.

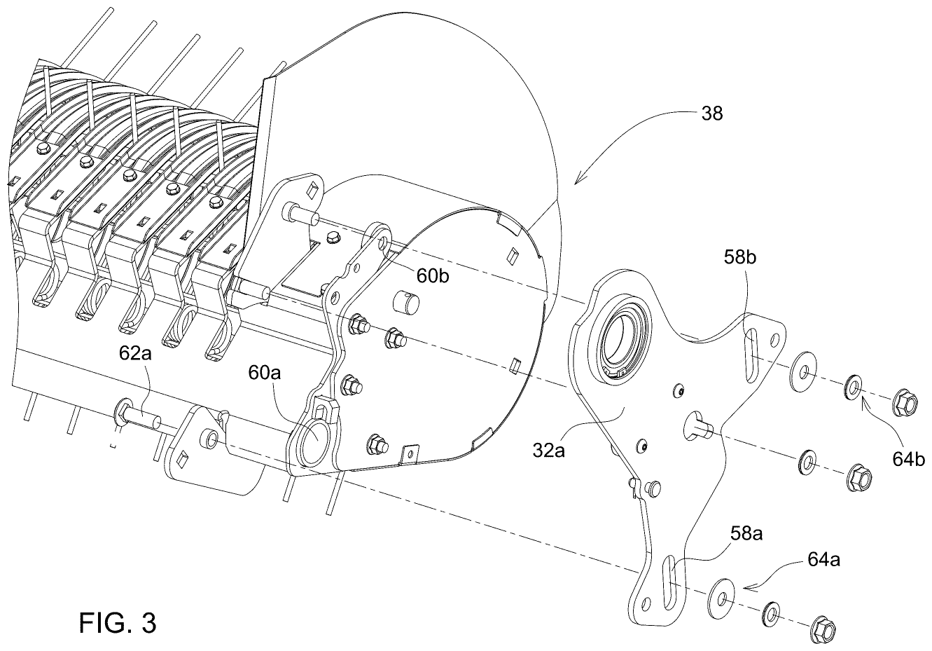

Recesses 60a, 60b (in this regard, see FIG. 3) are provided in the housing 38 of the pick-up device 34, into which recesses bearing journals 62a, 62b are inserted. The bearing journals 62a, 62b are received in the guide elements 58a, 58b and are secured by means of corresponding securing elements 64a, 64b, for example in the form of nuts, so as to be able to move in the direction of the longitudinal extent of the guide elements 58a, 58b.

The crop pick-up 22 furthermore has a traction mechanism drive 66 by means of which, in the present exemplary embodiment, at least the conveying rotor 30 and the conveying device 42 can be set in rotation. The traction mechanism drive 66 is driven by means of a drive pulley (not shown) and has a traction mechanism 68 in the form of a chain. The traction mechanism 68 is looped around a first drive pulley 70a, which is operatively connected to the conveying rotor 30, and a second drive pulley 66b, which is operatively connected to the conveying device 42. The drive pulleys 70a, 70b are in the form of toothed wheels. The traction mechanism drive 66 furthermore has a tensioning device 72 having a spring-loaded tensioning arm 74 which bears a tensioning pulley 76 likewise in the form of a toothed wheel, which tensions, or maintains a tension in, the traction mechanism 68 in a known manner.

During operation, the crop pick-up 22 is supported on the ground via the support wheels 40a, 40b and follows the ground 18 when the working implement 10 is towed over the field by the towing vehicle (not shown). If the contour of the ground 18 changes in the direction of travel, then the crop pick-up 22, and in particular the pick-up device 34, follows said contour by virtue of said pick-up device, or the articulation levers 32a, 32b that support the pick-up device 34, pivoting about the axis 36.

The contour however often also changes transversely with respect to the direction of travel. In particular in the case of particularly wide crop pick-up means such as are commonly used nowadays in order to achieve a high throughput, a very significant height difference can arise between the support wheels 40a, 40b. In order to compensate such a height difference, or in order to be able to better and/or more quickly follow the contour of the ground, provision is made in the present exemplary embodiment for the pick-up device 34 to be received substantially vertically movably (as indicated by arrows) in the articulation levers 32a, 32b that support it.

Here, the right-hand-side bearing journals 62a in relation to the direction of travel of the working implement 10, and the corresponding left-hand-side bearing journals 62b (not shown), can move at least substantially in parallel. However, if the ground 18 or the contour of the ground 18 requires height compensation, then the right-hand-side and left-hand-side bearing journals 62a, 62b can each independently move vertically in the guide elements 58a, 58b. In this way, the pick-up device 34 can perform a swinging movement without the need to provide a fixed swing axis for this purpose. Rather, a further degree of freedom is provided, which can be superposed on the purely vertical movement of the pick-up device 34.

Since the pick-up device 34 is correspondingly received or supported in the vertically extending guide elements 58 in the articulation levers 32a, 32b, this additional degree of freedom does not have an effect on the traction mechanism drive 66 or the traction mechanism 68, thus ensuring that the conveying rotor 38 and conveying device 42 are driven uniformly even in the case of significantly uneven ground.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A crop pick-up for an agricultural working implement, the crop pick-up comprising:
a pick-up device which is supported on the ground via at least one support wheel;
at least two articulation levers configured for attachment to a housing of the agricultural working implement, wherein the at least two articulation elvers are horizontally spaced apart from each other and support the pick-up device therebetween; and
wherein each of the at least two articulation levers includes at least one guide element configured for moveably supporting the pick-up device for movement of the pick up device in a substantially vertical direction relative to the articulation levers.

2. The crop pick-up set forth in claim 1, wherein the at least two articulation levers are configured for rotatable attachment to the housing for rotation about a substantially horizontal axis that extends transversely with respect to a direction of travel, whereby the at least two articulation levers may swing relative to the housing.

3. The crop pick-up set forth in claim 1, wherein at least one of the at least two articulation levers includes multiple guide elements arranged in a substantially parallel relationship relative to each other.

4. The crop pick-up set forth in claim 1, wherein each of the at least one guide element of the at least two articulation levers include a slot formed through a respective one of the at least two articulation levers.

5. The crop pick-up set forth in claim 4, further comprising a respective bearing journal extending through each of the at least one guide element of the at least two articulation levers.

6. The crop pick-up set forth in claim 2, further comprising a conveying rotor configured for rotation about the horizontal axis.

7. The crop pick-up set forth in claim 6, wherein the pick-up device includes a rotatable conveying device in the form of a spike rotor.

8. The crop pick-up set forth in claim 7, wherein the conveying rotor and the conveying device are rotatably driven by a traction mechanism drive.

9. The crop pick-up set forth in claim 8, wherein the traction mechanism drive includes a chain drive.

10. An agricultural working implement comprising:
a frame supporting a housing and including a running gear for moveably supporting the frame relative to a ground surface;
a crop pick-up including a pick-up device which is partially supported on the ground surface via at least one support wheel, and which includes at least two articulation levers coupled to the housing, wherein the at least two articulation elvers are horizontally spaced apart from each other and support the pick-up device therebetween; and
wherein each of the at least two articulation levers includes at least one guide element configured for moveably supporting the pick-up device for movement of the pick up device in a substantially vertical direction relative to the articulation levers.

11. The agricultural working implement set forth in claim 10, wherein the at least two articulation levers are configured for rotatable attachment to the housing for rotation about a substantially horizontal axis that extends transversely with respect to a direction of travel, whereby the at least two articulation levers may swing relative to the housing.

12. The agricultural working implement set forth in claim 10, wherein at least one of the at least two articulation levers includes multiple guide elements arranged in a substantially parallel relationship relative to each other.

13. The agricultural working implement set forth in claim 10, wherein each of the at least one guide element of the at least two articulation levers include a slot formed through a respective one of the at least two articulation levers.

14. The agricultural working implement set forth in claim 13, further comprising a respective bearing journal extending through each of the at least one guide element of the at least two articulation levers.

15. The agricultural working implement set forth in claim 11, further comprising a conveying rotor configured for rotation about the horizontal axis.

16. The agricultural working implement set forth in claim 15, wherein the pick-up device includes a rotatable conveying device in the form of a spike rotor.

17. The agricultural working implement set forth in claim 16, wherein the conveying rotor and the conveying device are rotatably driven by a traction mechanism drive.

18. The agricultural working implement set forth in claim 17, wherein the traction mechanism drive includes a chain drive.
